(19) United States
(12) Patent Application Publication
(10) Pub. No.: US 2025/0155300 A1
(43) Pub. Date: May 15, 2025

(54) EMBEDDED FIBER-SHAPED MECHANOLUMINESCENCE PEROVSKITE DEVICE FOR IN SITU STRUCTURAL HEALTH MONITORING OF COMPOSITE MATERIALS

(71) Applicant: Florida State University Research Foundation, Inc., Tallahassee, FL (US)

(72) Inventors: Lucas Braga Carani, Tallahassee, FL (US); Okenwa Okoli, Tallahassee, FL (US)

(21) Appl. No.: 18/935,789

(22) Filed: Nov. 4, 2024

Related U.S. Application Data
(60) Provisional application No. 63/598,570, filed on Nov. 14, 2023.

(51) Int. Cl. G01L 1/24

(52) U.S. Cl. CPC G01L 1/24

(57) ABSTRACT

In one aspect, the disclosure relates to fiber-shaped mechanoluminescent perovskite sensors, methods of making the same, composite laminate materials comprising the same, methods of sensing damage in composite laminate materials, and articles including the composite laminate materials. The fiber-shaped mechanoluminescent perovskite sensors are durable, are flexible and thus compatible with various structural arrangements including structures with curves, and do not disrupt the structural integrity of the materials in which they are embedded. In another aspect, the disclosed sensors are capable of pinpointing the precise location of barely visible impact damage and of being integrated into existing data transmission systems.

### CROSS-REFERENCE TO RELATED APPLICATIONS

This application claims the benefit of and priority to co-pending U.S. Provisional Patent Application No. 63/598,570, filed on Nov. 14, 2023, the contents of which are incorporated by reference herein in their entireties.

### STATEMENT REGARDING FEDERALLY SPONSORED RESEARCH OR DEVELOPMENT

This invention was made with government support under grant number 1950500 awarded by the National Science Foundation. The government has certain rights in the invention.

### BACKGROUND

The need for reliable structural health monitoring (SHM) systems continues to grow in importance across materials science and engineering, finding applications in industries such as aerospace, civil infrastructure, and renewable energy. The aerospace industry, for example, operates in conditions where even minor structural flaws can have disastrous consequences. A reliable SHM system can mean the difference between a regular flight and a disaster. Similarly, in the field of renewable energy, structures such as wind turbines are subjected to constant environmental stress. The continuous and autonomous monitoring of impact damage in composite structures is of particular interest and is an area that has been the subject of extensive research. Despite the advancements in conventional SHM technologies, these often fall short in power efficiency, size, and compatibility with the host structure, underscoring the need for innovative solutions.

The planar mechanoluminescent (ML)-perovskite sensor, a prior technology in Structural Health Monitoring (SHM), operates on a flat architecture where mechanoluminescent materials, subjected to mechanical stress, emit light that is detected by perovskite photodetectors to generate electrical data. However, this design presents challenges. Its flat, rigid nature complicates seamless integration into composite structures, especially those with intricate curvatures. The spatial resolution is limited, often making it tough to pinpoint exact impact locations. Embedding such a sensor can disrupt a composite's structural integrity, potentially weakening it. While these sensors provide some level of bendability, they lack the robust flexibility needed for complex structural applications. Additionally, integrating power sources or data transmission systems into these planar sensors can be cumbersome, often necessitating extra external components. Over time and repeated stresses, the planar design might also see diminished durability, especially at its edges. Thus, while foundational, the planar ML-perovskite's limitations highlight the need for the advanced fiber-shaped ML-perovskite design for more efficient, versatile SHM in composites.

Currently known sensors are limited in efficiency, sensitivity, and compatibility with various structural applications. They are also time-consuming to construct and structures incorporating these sensors must be shut down for inspections and maintenance.

Despite advances in structural health monitoring research, there is still a scarcity of sensor architectures that can be integrated into composite structures, including curved structures. There is further a scarcity of sensor architectures capable of pinpointing exact locations of damage. An ideal sensor would also be robustly flexible and capable of integration with power sources and/or data transmission systems. An ideal sensor would further be durable across the surface, including at the edges. These needs and other needs are satisfied by the present disclosure.

### SUMMARY

In accordance with the purpose(s) of the present disclosure, as embodied and broadly described herein, the disclosure, in one aspect, relates to fiber-shaped mechanoluminescent perovskite sensors, methods of making the same, composite laminate materials comprising the same, methods of sensing damage in composite laminate materials, and articles including the composite laminate materials. The fiber-shaped mechanoluminescent perovskite sensors are durable, are flexible and thus compatible with various structural arrangements including structures with curves, and do not disrupt the structural integrity of the materials in which they are embedded. In another aspect, the disclosed sensors are capable of pinpointing the precise location of barely visible impact damage and of being integrated into existing data transmission systems.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a schematic of an exemplary fiber-shaped ML-perovskite sensor according to the present disclosure. FIG. 1B shows a scheme for constructing the fiber-shaped ML-perovskite sensor.

FIG. 2A shows a schematic of the embedment process. FIG. 2B shows a vacuum bagging setup. FIG. 2C shows a composite sample with the embedded sensor according to one embodiment of the present disclosure.

FIG. 3A shows a schematic of a testing setup useful according to the present disclosure, while FIG. 3B is a photograph of actual testing conditions.

FIG. 4A shows current-voltage characteristic (I-V) curves of an exemplary perovskite photodetector under dark and light conditions. FIG. 4B shows on-off cycles of the photodetector.

FIG. 5 shows sensor response for different impact energies.

FIG. 6 shows tensile specimen configurations for no sensor (baseline, left), planar sensor (center), and wire-shaped sensor (right).

FIG. 7 shows flexural specimen configurations for no sensor (baseline, left), planar sensor (center), and wire-shaped sensor (right).

FIG. 8 shows a scanning electron microscope (SEM) image of an exemplary braided carbon nanotube (CNT) yarn.

FIG. 9A shows SEM of an SnO₂ coated CNT yarn. FIG. 9B shows an enlarged image of the fiber surface.

FIG. 10A shows SEM of a perovskite layer coated on CNT yarn/SnO₂. FIG. 10B shows an enlarged image of the fiber surface.

FIG. 11A shows a stress-strain curve showing a comparison of a control sample, a sample with an embedded wire sensor, and a sample with an embedded planar sensor. FIG. 11B shows a tensile strength comparison of the same samples. FIG. 11C shows tensile modulus of the same samples.

FIG. 12A shows a stress-strain curve showing a comparison of a control sample, a sample with an embedded wire sensor, and a sample with an embedded planar sensor. FIG. 12B shows a flexural strength comparison of the same samples. FIG. 12C shows flexural modulus of the same samples.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Integrating fiber-shaped sensors into composite materials holds tremendous potential for various sectors, including aerospace, automotive, civil engineering, energy production, and sporting goods industries. These sectors frequently utilize composite materials, valuing their exceptional strength-to-weight ratio and customizable properties. The inclusion of fiber sensors within these composites offers the capacity for real-time monitoring and early detection of damage or structural issues. Such capabilities could lead to more efficient maintenance scheduling, enhanced safety measures, and an extension in the service life of the composite structures.

Notably, the economic implications of employing fiber-shaped sensors are significant. Early damage detection facilitated by these sensors could considerably reduce inspection and maintenance costs. Furthermore, these sensors present a cost-effective solution by prolonging the service life of structures and reducing material waste through less intrusive sensor embedment. Developing fiber-shaped sensors also opens avenues for further advancements in smart materials and structures, potentially inspiring novel applications and innovative product development.

Disclosed herein is a novel fiber-shaped ML-perovskite sensor for in-situ impact detection in composite materials, which addresses many of the limitations associated with traditional SHM systems. In one aspect, the sensor's core is made of carbon nanotube (CNT) yarn. CNTs, with their distinct mechanical and electrical properties, serve as the foundation for the subsequent layers' stability and responsiveness. In a further aspect, the next layer is the tin oxide (SnO₂) layer, which not only aids in signal transmission but also ensures that the subsequent layers adhere well. In still another aspect, a perovskite active layer is then applied. In one aspect, the unique optoelectronic properties of perovskite make it an excellent choice for capturing and translating light emissions, particularly those produced by mechanoluminescent events, into readable electrical signals. In another aspect, the sensor's design is completed with a mechanoluminescent ZnS:Cu-polydimethylsiloxane (PDMS) layer that serves two functions. It is sensitive enough to emit light at the slightest mechanical stress or impact, and it also serves as a protective shield during the embedment process in composite structures.

In one aspect, the ML-perovskite sensor is an innovative combination of ML and a perovskite photodetector, assembled in a vertical structure that includes carbon nanotube (CNT) yarn as the electrodes, tin oxide (SnO₂) as the electron transport layer, and the perovskite as the active layer. The ML layer, composed of ZnS:Cu-PDMS, serves a dual purpose. In an aspect, the ML layer responds to mechanical stress or impact by emitting light, a property characteristic of its mechanoluminescent nature. In a further aspect, the ML layer functions as an encapsulation layer, providing the necessary protection for the sensor during the embedment process in the composite structure.

In an aspect, upon impact, the emitted light from the ML layer is captured by the perovskite photodetector, which converts the collected light into an electrical current. In a further aspect, this current is continuously monitored and used to correlate the impact damage. Without wishing to be bound by theory, the self-powered capability of the sensor is attributed to the unique optoelectronic properties of the perovskite structure, allowing it to convert optical signals into electrical signals without an external power source. In one aspect, this feature makes this fiber-shaped sensor particularly suitable for monitoring structures with limited or unreachable power supply, such as offshore wind turbines or spacecraft.

In one aspect, when the composite structure experiences an impact, the absorbed impact energy travels to the embedded sensor, activating the mechanoluminescent layer to emit light due to the mechanical stimuli. In a further aspect, tis emitted light is subsequently captured by the adjacent photodetector layer and converted into an electrical current. In another aspect, variations in this electrical current can be directly correlated to the extent of damage sustained by the composite structure, allowing for real-time damage assessment. In a still further aspect, the ML-perovskite sensors disclosed herein seamlessly integrate within composite materials while maintaining the materials' inherent properties.

In some aspects, the sensor's design capitalizes on the minimal size and superior flexibility of CNT yarns, allowing for optimal conformation to various structural geometries and ensuring an unobtrusive presence within the host material. In contrast to the bulkier and more rigid polyethylene-indium tin oxide (PET-ITO) utilized in planar-shaped devices, the CNT-based construction enables enhanced spatial resolution and early damage detection.

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a metal halide perovskite,” “a metal oxide,” or “a carbon nanotube yarn,” include, but are not limited to, mixtures, combinations, or groups of two or more such metal halide perovskites, metal oxides, or carbon nanotube yarns, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

“Barely visible impact damage” or “BVID” refers to impact damage to a composite material that cannot easily be seen by the human eye. BVID typically occurs under low-impact energy and can be difficult to detect. In one aspect, BVID is typically minor damage to a composite material's surface; however, this damage can be structurally significant internal to the laminate composite, leading to delamination, matrix cracking, or the like. In one aspect, the disclosed fiber-shaped mechanoluminescent perovskite sensors are able to pinpoint the location of BVID.

“Mechanoluminescence” is light emission that results from a mechanical action on a solid. In one aspect, the outermost layer of the disclosed fiber-shaped perovskite sensors includes a mechanoluminescent material that emits light when a composite material including the sensor is affected by impact damage such as, for example, BVID.

A “fiber” or a material that is “fiber-shaped” refers to a material with a diameter or average diameter significantly narrower than the length of the material.

### Fiber-Shaped Mechanoluminescent Perovskite Sensors

In one aspect, disclosed herein is a fiber-shaped mechanoluminescent perovskite sensor including at least the following components: a core electrode including or made from carbon nanotube yarn; an SnO₂ layer deposited on the core electrode; a perovskite active layer in contact with the SnO₂ layer; a second electrode including or made from carbon nanotube yarn in contact with the perovskite active layer; and a mechanoluminescent layer encapsulating the sensor.

In some aspects, the core electrode, the second electrode, or both include a plurality of carbon nanotube yarn strands, wherein the strands are braided together. Any technique known in the art for braiding yarns can be used although, in some aspects, the strands are braided using a kumihimo technique or a Maypole braider. In one aspect, the plurality of carbon nanotube yarn strands is made up of four individual strands. In some aspects, the second electrode is wrapped around the perovskite active layer in a spiral shape or pattern.

### Arrangement of CNT Yarns

In one aspect, braiding techniques such as kumihimo offer unique advantages when applied to CNT yarns for the disclosed fiber-shaped sensors. In a further aspect, braiding techniques involve interlacing multiple threads to form intricate and robust structures, contributing to braided CNT yarn's improved mechanical properties. In an additional aspect, braiding prevents the fibers from unraveling, unlike twisting, ensuring a stable and durable structure.

Kumihimo is a traditional Japanese braiding technique adapted for various applications, including the handling of CNT yarns. “Kumihimo” translates to “gathered threads” and refers to creating complex yet elegant braid patterns by systematically intertwining threads around a central axis. In one aspect, in the context of CNT yarns, using a 4-thread kumihimo technique provides an optimal balance of strength, flexibility, and uniformity.

In a further aspect, the braiding process results in several advantages for the disclosed fiber-shaped sensors. In another aspect, braiding provides for enhanced mechanical properties, including tensile strength and abrasion resistance. In a further aspect, and without wishing to be bound by theory, due to the intertwined nature of braided structures, stress is more evenly distributed across the fibers, leading to increased resilience. In a still further aspect, braiding also helps maintain the structural integrity of the CNT yarns by preventing unraveling, which can be a common issue in twisted fibers.

In another aspect, an advantage of using kumihimo braiding techniques with CNT yarns is the increased surface area exposure, which facilitates the uniform coating of perovskite and other solutions. In one aspect, this improved surface adhesion ensures a consistent and reliable sensing response.

In a still further aspect, superior handling characteristics are also afforded by braiding since the individual threads are less prone to tangling and can be more easily manipulated. In one aspect, this ease of handling is particularly valuable during manufacturing and when incorporating braided yarns into various applications.

In still another aspect, in the case of coating CNT yarns, the capillary effect aids in uniformly spreading a solution throughout the fibers, especially in the narrow spaces and interstices created by the braiding technique. In one aspect, as the solution is applied to the yarn, it is drawn into the interwoven structure through the capillary forces, ensuring an even distribution of the coating material and ensuring a consistent and reliable sensing response for products made using the braided yarn.

In still another aspect, braiding techniques increase the surface area exposure of the CNT yarns, which enhances the capillary effect and promotes a more efficient and uniform coating. The intricate patterns formed by the braided structure also provide a more significant number of contact points for the solution, facilitating better adhesion and improved sensing capabilities.

### Perovskite Active Layer

In one aspect, the perovskite active layer includes or is made from a methylammonium lead halide perovskite. In another aspect, the methylammonium lead halide perovskite has the formula MAPb(BrₛI₁₋ₓ)₃, wherein x is from 0.05 to 0.9, or wherein x is 0.05, 0.1, 0.15, 0.2, 0.25, 0.3, 0.35, 0.4, 0.45, 0.5, 0.55, 0.6, 0.65, 0.7, 0.75, 0.8, 0.85, or 0.9, or a combination of any of the foregoing values, or a range encompassing any of the foregoing values. In some aspects, x is 0.1.

### Mechanoluminescent Layer

In some aspects, the mechanoluminescent layer includes at least one metal or metal chalcogenide and a polymeric material. In one aspect, the metal or metal chalcogenide can be Cu, ZnS, or both Cu and ZnS. In another aspect, the polymeric material includes polydimethylsiloxane.

### Method for Making the Sensors

In an aspect, disclosed herein is a method of making a fiber-shaped mechanoluminescent perovskite sensor, the method including at least the steps of:
(a) depositing a layer of SnO₂ on a core CNT yarn;
(b) applying a perovskite active layer to the SnO₂;
(c) wrapping a second CNT yarn around the perovskite active layer to form a wrapped sensor; and
(d) encapsulating the wrapped sensor with a mechanoluminescent layer.

In another aspect, the method includes braiding a plurality of CNT strands to form the CNT yarn prior to step (a). In a further aspect, the plurality of CNT strands can include four CNT strands and the strands can be braided using kumihimo or a Maypole braider.

In another aspect, step (a) can include drip coating a colloidal SnO₂ solution on the CNT yarn. In a still further aspect, following drop coating, the colloidal SnO₂ solution can be dried, annealed using joule heating, or both.

In one aspect, step (b) includes drip coating a perovskite precursor solution on the layer of SnO₂. In a further aspect, the perovskite precursor solution includes Ch₃NH₃I, PbBr₂, and PbI₂ in a solvent such as, for example, N-methylpyrrolidone. In some aspects, the perovskite precursor solution further includes a crystallization assistant such as, for example, gamma-butyrolactone.

In any of these aspects, step (b) further includes drying the perovskite precursor solution on the layer of SnO₂ to form a perovskite active layer, using joule heating to thermally anneal the perovskite active layer, or both.

In another aspect, the method includes braiding a second plurality of CNT strands to form the second CNT yarn prior to step (c). In a further aspect, the second plurality of CNT strands can include four CNT strands and the strands can be braided using kumihimo or a Maypole braider. Further aspect, the second CNT yarn can be wrapped around the perovskite active layer in a spiral.

In yet another aspect, step (d) includes drip-coating a mechanoluminescent layer precursor solution onto the wrapped sensor. In some aspects, the mechanoluminescent precursor solution includes at least one metal or metal chalcogenide and a polymeric material. In one aspect, the metal or metal chalcogenide can be Cu, ZnS, or both Cu and ZnS. In another aspect, the polymeric material includes polydimethylsiloxane. In any of these aspects, step (d) can further include curing the mechanoluminescent layer precursor solution using joule heating to form the mechanoluminescent layer.

Also disclosed are sensors made by the disclosed method.

### Composite Materials

In an aspect, disclosed herein is a composite material including one or more of the disclosed fiber-shaped mechanoluminescent perovskite sensors as disclosed herein. In some aspects, the composite material is a composite laminate material and can include one or more carbon fiber (CF) layers, one or more glass fiber (GF) layers, or any combination thereof. In a further aspect, the carbon fiber layers, the glass fiber layers, or both can be or include a woven fabric. In any of these aspects, the composite material has a configuration of CF/GF/GF/GF/CF. In one aspect, the disclosed sensor is embedded in a GF layer.

### Method of Sensing Impact Damage

In one aspect, disclosed herein is a method of sensing impact damage to a disclosed composite material, the method including at least the steps of:
(a) emission of light by the mechanoluminescent layer, wherein light emission occurs upon detection of an impact energy;
(b) conversion of the light to an electrical signal by the perovskite active layer; and
(c) detecting the electrical signal.

In another aspect, in the disclosed method, the impact energy can be greater than or equal to about 1.5 J, or can be about 1.5, 2, 2.5, 3, 3.5, 4, 4.5, or about 5 J, or a combination of any of the foregoing values, or a range encompassing any of the foregoing values. In some aspects, the damage is barely visible impact damage (BVID).

### Articles Including the Sensors and Composite Material

Also disclosed herein are articles including the disclosed sensors and composite materials. In one aspect, the article can be an aerospace component, an infrastructure component, an automotive component, an energy production component, or an article of sporting equipment.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

Aspect 1. A fiber-shaped mechanoluminescent perovskite sensor comprising:
a core electrode comprising carbon nanotube yarn;
an SnO₂ layer deposited on the core electrode;
a perovskite active layer in contact with the SnO₂ layer;
a second electrode comprising carbon nanotube yarn in contact with the perovskite active layer; and a mechanoluminescent layer encapsulating the sensor.

Aspect 2. The sensor of Aspect 1, wherein the core electrode comprises a plurality of carbon nanotube yarn strands, wherein the plurality of carbon nanotube yarn strands are braided together.

Aspect 3. The sensor of Aspect 2, wherein the strands are braided using a kumihimo technique or a Maypole braider.

Aspect 4. The sensor of Aspect 2 or 3, wherein the plurality of individual carbon nanotube yarn strands consists of four strands.

Aspect 5. The sensor of any one of Aspects 1-4, wherein the perovskite active layer comprises a methylammonium lead halide perovskite.

Aspect 6. The sensor of Aspect 5, wherein the methylammonium lead halide perovskite has the formula MAPb(BrₛI₁₋ₓ)₃, wherein x is from 0.05 to 0.9.

Aspect 7. The sensor of Aspect 6, wherein x is 0.1.

Aspect 8. The sensor of any one of Aspects 1-7, wherein the second electrode is wrapped around the perovskite active layer in a spiral shape.

Aspect 9. The sensor of any one of Aspects 1-8, wherein the second electrode comprises a plurality of carbon nanotube yarn strands, wherein the plurality of carbon nanotube yarn strands are braided together.

Aspect 10. The sensor of Aspect 9, wherein the strands are braided using a kumihimo technique or a Maypole braider.

Aspect 11. The sensor of Aspect 9 or 10, wherein the plurality of individual carbon nanotube yarn strands consists of four strands.

Aspect 12. The sensor of any one of Aspects 1-11, wherein the mechanoluminescent layer comprises at least one metal or metal chalcogenide and a polymeric material.

Aspect 13. The sensor of Aspect 12, wherein the metal or metal chalcogenide comprises Cu, ZnS, or both Cu and ZnS.

Aspect 14. The sensor of Aspect 12 or 13, wherein the polymeric material comprises polydimethylsiloxane.

Aspect 15. A method of making a fiber-shaped mechanoluminescent perovskite sensor, the method comprising:
(a) depositing a layer of SnO₂ on a core CNT yarn;
(b) applying a perovskite active layer to the SnO₂;
(c) wrapping a second CNT yarn around the perovskite active layer to form a wrapped sensor; and
(d) encapsulating the wrapped sensor with a mechanoluminescent layer.

Aspect 16. The method of Aspect 15, further comprising braiding a plurality of CNT strands to form the core CNT yarn prior to step (a).

Aspect 17. The method of Aspect 16, wherein the plurality of CNT strands comprises four CNT strands.

Aspect 18. The method of Aspect 16 or 17, wherein the plurality of CNT strands are braided using kumihimo or a Maypole braider.

Aspect 19. The method of any one of Aspects 15-18, wherein step (a) comprises drip coating a colloidal SnO₂ solution on the core CNT yarn.

Aspect 20. The method of Aspect 19, further comprising drying the colloidal SnO₂ solution on the core CNT yarn.

Aspect 21. The method of Aspect 20, further comprising using joule heating to thermally anneal the dried SnO₂ solution.

Aspect 22. The method of any one of Aspects 15-21, wherein step (b) comprises drip coating a perovskite precursor solution on the layer of SnO₂.

Aspect 23. The method of Aspect 22, wherein the perovskite precursor solution comprises Ch₃NH₃I, PbBr₂, and PbI₂ in a solvent.

Aspect 24. The method of Aspect 23, wherein the solvent comprises N-methylpyrrolidone.

Aspect 25. The method of any one of Aspects 22-24, wherein the perovskite precursor solution further comprises a crystallization assistant.

Aspect 26. The method of Aspect 25, wherein the crystallization assistant comprises gamma-butyrolactone.

Aspect 27. The method of Aspect any one of Aspects 22-26, further comprising drying the perovskite precursor solution on the layer of SnO₂ to form a perovskite active layer.

Aspect 28. The method of Aspect 27, further comprising using joule heating to thermally anneal the perovskite active layer.

Aspect 29. The method of any one of Aspects 15-28, further comprising braiding a second plurality of CNT strands to form the second CNT yarn prior to step (c).

Aspect 30. The method of Aspect 29, wherein the second plurality of CNT strands comprises four CNT strands.

Aspect 31. The method of Aspect 29 or 30, wherein the second plurality of CNT strands are braided using kumihimo or a Maypole braider.

Aspect 32. The method of any one of Aspects 15-31, wherein the second CNT yarn is wrapped around the perovskite active layer in a spiral.

Aspect 33. The method of any one of Aspects 15-32, wherein step (d) comprises drip-coating a mechanoluminescent layer precursor solution onto the wrapped sensor.

Aspect 34. The method of Aspect 33, wherein the mechanoluminescent layer precursor solution comprises at least one metal or metal chalcogenide and a polymeric material.

Aspect 35. The method of Aspect 34, wherein the metal or metal chalcogenide comprises Cu, ZnS, or both Cu and ZnS.

Aspect 36. The method of Aspect 34 or 35, wherein the polymeric material comprises polydimethylsiloxane.

Aspect 37. The method of any one of Aspects 33-36, further comprising curing the mechanoluminescent layer precursor solution using joule heating to form the mechanoluminescent layer.

Aspect 38. A sensor made by the method of any one of Aspects 15-37.

Aspect 39. A composite material comprising one or more sensors according to any one of Aspects 1-14 or 38.

Aspect 40. The composite material of Aspect 39, wherein the composite material is a composite laminate material.

Aspect 41. The composite material of Aspect 40, wherein the composite laminate material comprises one or more carbon fiber (CF) layers, one or more glass fiber (GF) layers, or any combination thereof.

Aspect 42. The composite material of Aspect 41, wherein the carbon fiber layers, the glass fiber layers, or both comprise a woven fabric.

Aspect 43. The composite material of Aspect 41 or 42, wherein the composite laminate material comprises a configuration of CF/GF/GF/GF/CF.

Aspect 44. The composite material of any one of Aspects 41-43, wherein the sensor is embedded in a GF layer.

Aspect 45. A method of sensing impact damage to a composite material comprising the sensor of any one of Aspects 1-14 or 38, the method comprising:
(a) emission of light by the mechanoluminescent layer, wherein light emission occurs upon detection of an impact energy;
(b) conversion of the light to an electrical signal by the perovskite active layer; and
(c) detecting the electrical signal.

Aspect 46. The method of Aspect 45, wherein the impact energy is greater than or equal to 1.5 J.

Aspect 47. The method of Aspect 45 or 46, wherein the impact energy comprises barely visible impact damage (BVID).

Aspect 48. An article comprising the composite material of any one of Aspects 39-44

Aspect 49. The article of Aspect 48, wherein the article comprises an aerospace component, an infrastructure component, an automotive component, an energy production component, or an article of sporting equipment.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Materials and Methods

### Materials

Methylammonium iodide (CH₃NH₃I), gamma-butyrolactone (GBL), N-methyl-2-pyrrolidone (NMP), and diethyl ether (DEE) were procured from Sigma Aldrich. Lead iodide (PbI₂) was sourced from Acros Organics, while lead bromide (PbBr₂) and the SnO₂ colloid precursor (15% in H₂O colloidal dispersion) were obtained from Alfa Aesar. Nanocomp supplied CNT yarns. The ZnS:Cu phosphor GL29/B-C1 was purchased from Phosphor Technology Ltd.

### Fabrication of the Fiber-Shaped ML-Perovskite Sensor

The fabrication process of the fiber-shaped ML-Perovskite sensor began with the preparation of a CNT yarn as the lower electrode. To ensure uniform coating and enhanced structural stability for the fabrication process, the CNT yarns were braided using a four-strand kumihimo technique, thus providing a robust and well-structured framework for subsequent layer deposition.

A layer of SnO₂ was then deposited on the CNT yarn. The SnO₂ colloidal solution was diluted with deionized water, drip-coated onto the CNT yarn substrate, and dried at room temperature. A thermal annealing process was conducted via joule heating to ensure the proper formation of the SnO₂ layer.

Subsequently, the perovskite active layer was applied to the SnO₂ layer. The fabrication of the MAPb(Br_{0.1}I_{0.9})₃ perovskite layer began with preparing a precursor solution. 380 mg of CH₃NH₃1, 91.8 mg of PbBr₂, and 826.2 mg of PbI₂ were combined in a mixed solvent of 1 mL NMP and 0.2 mL GBL. The solution was then stirred continuously on a hot plate maintained at 70° C. overnight. The precursor solution underwent an additional heating period for 30 minutes at the same temperature immediately before the deposition process. This solution was then drip-coated onto the previously deposited SnO₂ layer and allowed to dry at room temperature. A secondary thermal annealing process was carried out using joule heating to ensure proper crystallization of the perovskite layer.

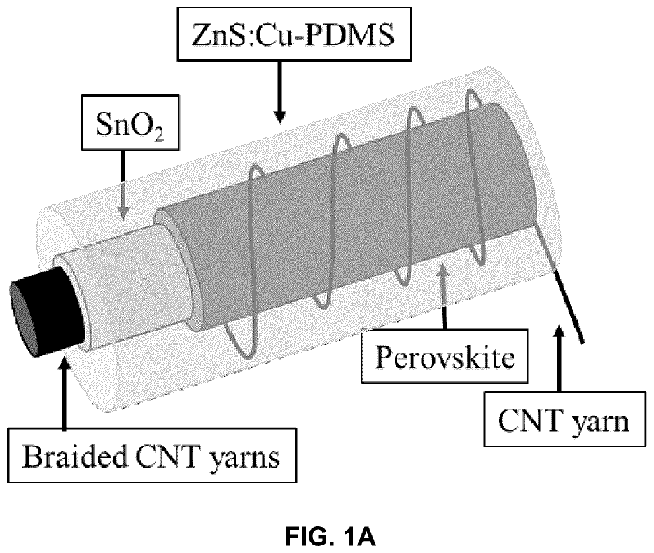

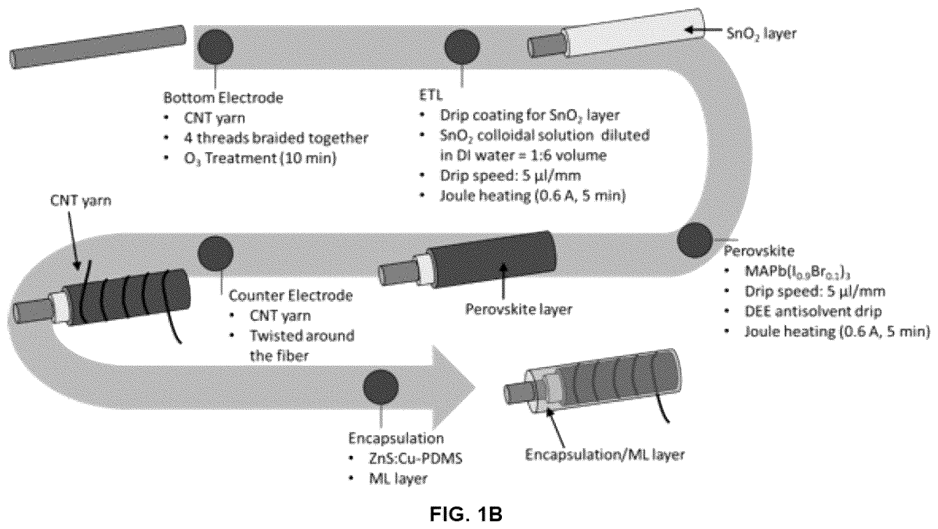

The upper electrode was formed by wrapping another braided CNT yarn around the perovskite layer. Next, the mechanoluminescent and encapsulation layers of ZnS:Cu-PDMS were prepared and drip-coated onto the structure. The ZnS:Cu-PDMS layer was subsequently cured using the joule heating method. A schematic of the sensor can be seen in FIG. 1A and a scheme for constructing an exemplary sensor can be seen in FIG. 1B.

### Sensor Embedment

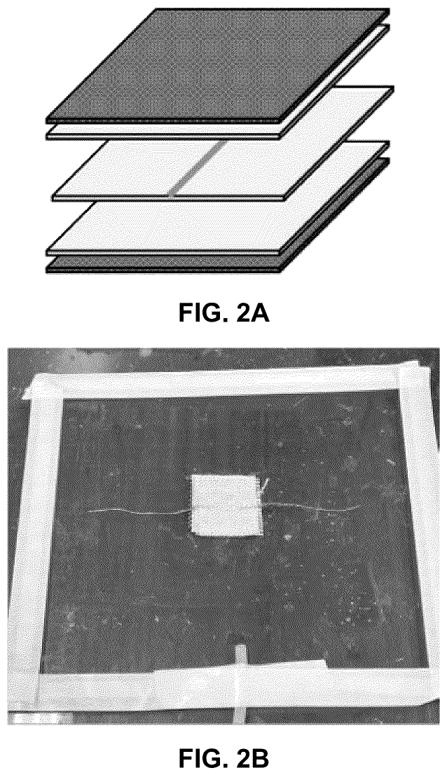

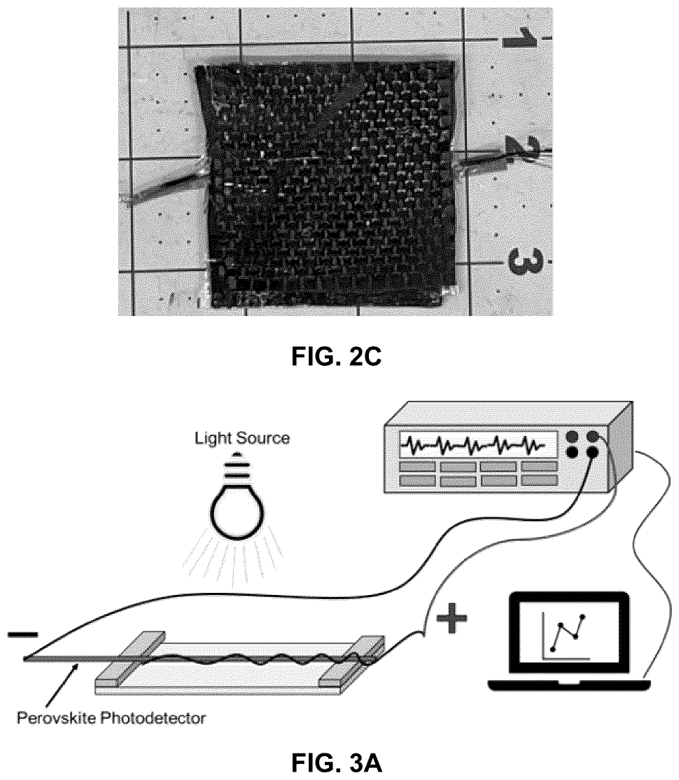

Following the sensor's fabrication, the device was woven within the middle glass fiber (GF) fabric and then embedded into a carbon fiber (CF)/GF composite laminate. The laminate layup configuration was CF/GF/GF/GF/CF, where all fabrics were woven, as seen in FIG. 2A. The use of GF layers served not only as the sensor's housing but also to prevent any potential electromagnetic interference from the CF. The composite layup process was done using the hand layup method with a vinyl ester resin and subsequently cured under vacuum bagging (FIG. 2B) conditions for 24 hours at room temperature. This method ensured complete resin curing and solidification of the laminate structure. FIG. 2C shows the final composite panel with the embedded sensor.

The first step in the embedment process involved weaving the sensor into the middle layer of a glass fiber (GF) woven fabric. Potential electromagnetic interference (EMI) that might originate from the carbon fiber can be effectively mitigated by encapsulating the sensor within a PDMS layer. However, for the purposes of this initial investigation, glass fiber was employed to preemptively circumvent any possible EMI. The weaving of the sensor followed a pattern that ensured its seamless integration into the fabric without disrupting the structure of the fibers.

The composite laminate was built following a specific configuration: CF/GF/GF/GF/CF, where CF represents a carbon fiber layer and GF represents a glass fiber layer. Each layer was woven to enhance the composite's structural integrity and ensure uniform load distribution. The sensor was strategically positioned within the GF layers, balancing mechanical protection and sensing performance. The sensor placement was also designed to minimize any potential interference with the composite's load-bearing capacity, thereby ensuring that the sensor embedment did not compromise the structural integrity of the composite laminate. FIGS. 2A-2C show the embedment process and the composite fabrication.

The composite layup process was carried out using the hand layup method, a widely adopted technique for its versatility and simplicity. This method allowed for careful placement and alignment of the fibers, ensuring uniform resin distribution throughout the laminate. A vinyl ester resin was chosen for its excellent bonding properties and compatibility with CF and GF layers.

After the layup, the laminate was cured under vacuum bagging conditions for 24 hours at room temperature. This stage was important to complete resin curing, vital for solidifying the laminate structure and its overall mechanical stability.

### Characterization and Performance Assessment

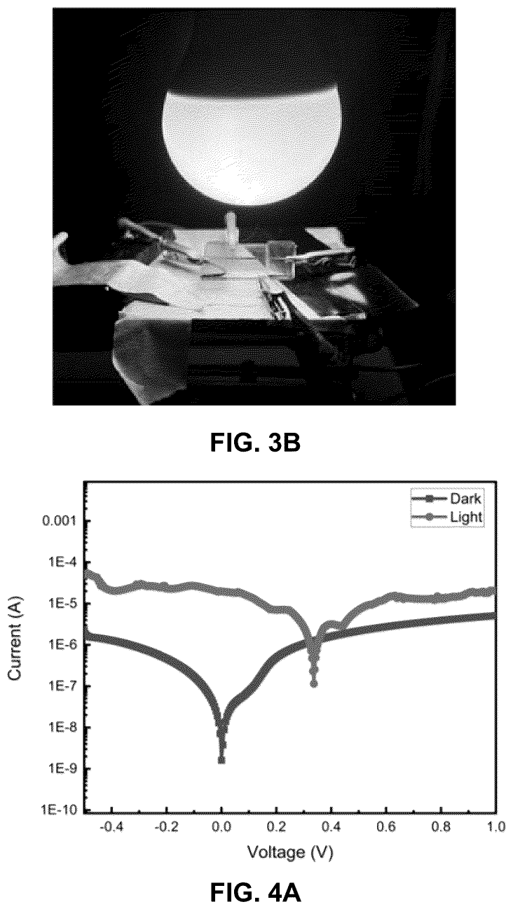

Electrical characterization of the ML-Perovskite sensor was performed using a Keithley 2410 source meter unit. Current-voltage (I-V) curves were subsequently obtained under both dark and illuminated conditions (FIGS. 3A-3B).

Mechanical characterization, specifically the sensor's response to impact loading, was carried out using a custom made drop tower. Impact energies were varied systematically in the range of 0.5 to 5 J to emulate a wide spectrum of potential real world impacts. This comprehensive series of impact tests was instrumental in assessing the sensor's capability to reliably detect impact events.

Scanning electron microscopy (SEM) was used for inspecting the sensor's surface morphology and coating thickness. SEM imaging enables an in-depth examination of the SnO₂ and perovskite layers on the CNT yarns at high magnification. This provides a detailed assessment of the uniformity and continuity of the coatings, vital for the sensor's overall functionality and performance.

In conjunction with SEM, energy dispersive spectroscopy (EDS) was employed for elemental analysis. This technique complements SEM by providing the elemental composition and spatial distribution of elements within the SnO₂ and perovskite layers. By identifying the presence and uniform distribution of the required elements in the layers, EDS analysis affirms the successful coating process and provides insights into the purity of the fabricated layers.

The electrical properties of the fabricated sensor, a fundamental aspect of its performance, were evaluated by recording current-voltage characteristic curves (I-V curves). For this purpose, a Keithley 2400 source measure unit was used. FIG. 3A illustrates the characterization process. In a typical photodetector I-V measurement, the applied voltage is swept from −0.5 V to 1 V to assess a photodetector's performance, including its photocurrent response and dark current.

The initial performance assessment of the embedded fiber-shaped sensor was primarily conducted through a series of controlled drop-tower tests, varying impact energies from 0 J to 5 J.

The drop-tower test method is used for generating and characterizing controlled impact events on composite structures, was particularly useful for the study of low-velocity impacts. The drop-tower setup involved a precisely machined weight falling from a predefined height to generate an impact on the composite laminate with the embedded sensor. The impact energy, a function of the weight's mass and the height from which it is dropped was adjusted to simulate a range of low-velocity impact scenarios that might be encountered in real-world applications. The objective of this approach was to replicate, as closely as possible, the conditions that could lead to barely visible impact damage (BVID), a concern in the composite industry.

Following each impact, the embedded sensor's output was collected in real-time, providing a direct measure of the sensor's performance in response to varying impact energies. The drop-tower test setup facilitated a controlled and replicable environment for the initial performance assessment.

The impact test results were then analyzed to elucidate the sensor's response and reliability under varying impact conditions. The understanding derived from this initial assessment is instrumental in evaluating the potential of the proposed sensor for real-time structural health monitoring in composite materials, particularly concerning low-energy impacts.

This initial performance assessment provided insights into the sensor's sensitivity, response time, and linearity concerning impact energy.

### Mechanical Intrusiveness Investigation

The mechanical intrusiveness of planar and fiber-shaped ML-perovskite sensors was assessed by examining their impact on the structural integrity of the host composite material. Key metrics such as stiffness, strength, and fracture toughness were used to quantify this intrusiveness.

When embedding elements to create an intelligent structure, the primary concern lies in the effect of the embedment on the load-carrying capability, structural life, and effective elastic modulus of the host composite material. These issues can be addressed by selecting a compatible, minimally-sized sensor that causes the least disruption to the fewest plies in the laminate. A comprehensive mechanical performance study was conducted to analyze the intrusiveness impact of embedding the ML sensor within a composite structure, comparing planar and wire-shaped configurations to understand the consequences of integrating these sensors.

Initial tests focused on traditional mechanical characterization techniques, such as tensile and three-point bending testing.

Testing samples with and without sensors allows the evaluation of their impact on the host material's mechanical performance. A clear understanding of tensile properties, such as tensile strength, modulus, and strain at failure, facilitates better sensor integration strategies, preserving the composite's mechanical performance while reducing stress concentration or resin pockets. This knowledge also provides insight into failure mechanisms in sensor-integrated composites, ensuring structural integrity and sensor functionality under diverse loading conditions. Ultimately, a comprehensive understanding of tensile properties drives sensor design optimization, minimizing their influence on the host material's performance and promoting the development of more efficient, reliable sensors for Structural Health Monitoring in composite structures.

The ASTM D3039 standard test method for tensile properties of polymer matrix composite materials encompasses determining the tensile properties, including tensile strength, modulus, Poisson's ratio, and strain at failure. The sample specimens are prepared by cutting them to the prescribed dimensions and shapes specified in the standard. The specimens are mounted on a universal testing machine equipped with the proper grips and extensometer during the test. The load is applied to the sample at a controlled rate until the specimen reaches failure. The resulting stress-strain curves are analyzed to obtain the tensile properties of the composite materials. The tests are typically performed under controlled environmental conditions, such as temperature and humidity, to ensure accurate and reliable data.

Flexural properties also provide information on the composite material's and embedded ML-perovskite sensors' response to bending forces. Flexural properties, such as flexural strength and modulus, help assess the composite's ability to resist bending and deformation without breaking or losing functionality.

Understanding flexural properties allows for assessing the impact of embedded sensors on the host material. Integrating sensors within composite materials can influence the composite materials' mechanical performance, similar to tensile properties. By conducting flexural tests on samples with and without embedded sensors, it is possible to determine the sensors' impact on the host material's bending strength, stiffness, and overall performance. Table 1 presents the summary of the specimens used in the testing.

TABLE 1
Summary of Dimensions of Tensile and Flexural Specimens

| | | |
|---|---|---|
| Length (mm) | Width (mm) | Thickness (mm) |

Tensile Samples

| | | | |
|---|---|---|---|
| Baseline (no sensor) | 250.37 ± 1.96 | 24.88 ± 0.04 | 2.57 ± 0.05 |
| Planar sensor | 251.39 ± 2.04 | 25.21 ± 0.60 | 2.82 ± 0.07 |
| Fiber sensor | 249.84 ± 1.56 | 24.98 ± 0.21 | 2.68 ± 0.07 |

Flexural Samples

| | | | |
|---|---|---|---|
| Baseline (no sensor) | 71.94 ± 0.01 | 16.92 ± 0.04 | 1.85 ± 0.06 |
| Planar sensor | 71.97 ± 0.02 | 16.96 ± 0.05 | 1.92 ± 0.12 |
| Fiber sensor | 71.96 ± 0.02 | 16.88 ± 0.07 | 1.87 ± 0.05 |

The ASTM D7264 standard test method for flexural properties of polymer matrix composite materials examines the behavior of composite materials subjected to flexural loading. This test method involves using a universal testing machine to conduct three-point bending tests on composite specimens, which are typically rectangular. The standard defines the support span and loading nose radius based on the specimen's thickness. During the test, a constant displacement rate is applied to the center of the specimen until failure occurs. This test method helps to determine the flexural strength, modulus, and strain at failure for composite materials.

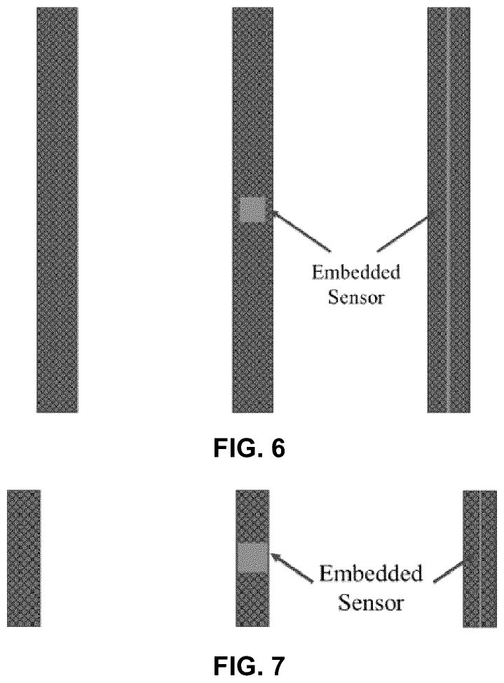

Tensile testing was performed following the ASTM-D3039. The schematic details of the test specimen are shown in FIG. 6. All the specimens were tested on a mechanical test system (MTS) Landmark servo-hydraulic universal testing machine at ambient laboratory conditions. The specimens were mounted between the grips of the MTS machine and monotonically loaded in tension while recording load and strain data until the final failure. Tensile tests were conducted at a loading speed of 1.0 mm/min. The maximum load carried before failure determined the material's ultimate strength.

The flexural tests were performed under a three-point bend configuration using a Shimadzu universal test machine to determine the flexural strengths and stiffness. ASTM-D7264 was adopted for testing. FIG. 7 shows the flexural composite specimen. All specimens have a span length of 72 mm to maintain a 32:1 span length/thickness ratio. The tests maintained the crosshead displacement rate of 1.0 mm/min. The tests continued until the specimens fractured and the load-displacement data was acquired. This mechanical testing method measures the behavior of materials subjected to simple bending loads. The flexural modulus (stiffness) is calculated from the slope of the bending load vs. deflection curve.

### Sensor Development Results

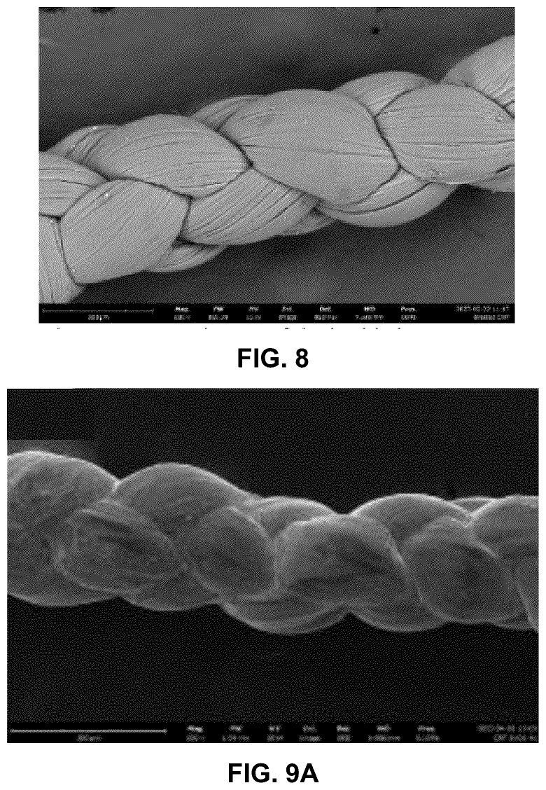

The choice to employ a braiding technique for the CNT yarns offered presents several advantages over single or twisted fibers. As substantiated by SEM images (FIG. 8), the braiding technique results in a uniform, compact structure, which allows for better electrical conductivity and forms an excellent substrate for the ensuing coatings. The SEM images show a uniform distribution of fibers in the braided structure, demonstrating an excellent preparation for uniform coatings and confirming the superiority of braiding. Automated alternatives like the Maypole braiding machines offer a time savings, however.

The SEM image in FIG. 8 shows the structural advantages provided by the braided CNT yarns for perovskite coating. The intricacy of the braiding process, clearly visible in the image, significantly increases the surface area of contact with the perovskite material, facilitating a more extensive and uniform coating application, which is expected to enhance sensor response. Furthermore, the compactness and robustness observed in the braided structure confer improved mechanical stability, indicating that the sensor can maintain its structural integrity under various conditions.

The small interstices visible in the braided structure also play a role in ensuring a uniform coating of the perovskite precursor solution over the CNT yarns. These minute spaces function as capillaries, drawing the solution into the yarn by capillary action. Alongside the mechanical and structural benefits, the braided CNT yarns also offer flexibility to the sensors without compromising their functionality or performance.

Capillary action ensures that the coating solution wicks along the CNT yarns evenly, ensuring a uniform coating. Joule heating expedites the evaporation of the solvent, resulting in the rapid formation of a uniform perovskite layer.

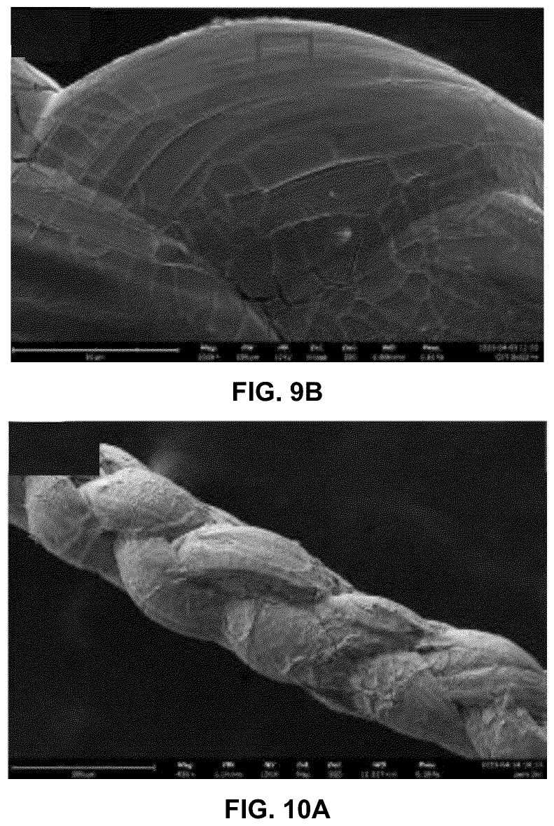

A drip coating method for applying SnO₂ and perovskite layers offers finer control and uniformity over a dip coating method. EDS and SEM analyses of these layers show an evenly distributed, homogeneous coating of SnO₂ and perovskite on the CNT yarns, as seen in FIGS. 9A-9B. Moreover, this technique promotes a more gradual and even crystallization process, reducing the likelihood of cracks and breaks, particularly within the perovskite layer.

The SEM image of the SnO₂-coated CNT yarn provides a detailed view of the structural details, showing the effectiveness of the drip-coating method in achieving a highly uniform SnO₂ layer. The image shows a surface uniformly coated with nanoscale SnO₂ particles firmly adhered to the CNT yarns. This uniformity of SnO₂ coating is expected to enhance the sensitivity and reproducibility of the sensor response, given the intimate contact between the CNT yarns and the SnO₂ particles, thereby improving charge transfer and sensor performance. Upon closer examination, the surface of the fiber demonstrates a good coverage of the SnO₂ coating, with almost no presence of voids within the braids of the CNT yarns.

EDS analysis provides a quantitative assessment of the elemental composition, confirming the successful coating of SnO₂ on the CNT yarns. The spectra exhibit the elemental peaks corresponding to Sn and O, thus verifying deposition of the SnO₂ coating. The EDS data also confirms the absence of any impurities or contaminants that could affect the sensor's performance.

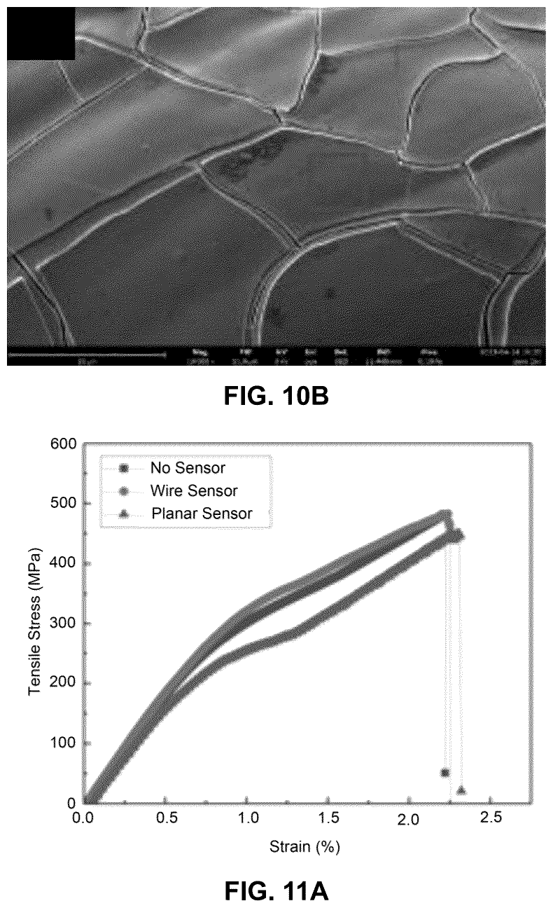

While standardization of the process is fundamental for scaling up the sensor size, perovskite crystallization on larger surfaces poses a challenge. SEM and EDS images reveal an acceptable perovskite layer on small-scale sensors (FIGS. 10A-10B).

The top CNT yarn electrode wrapping requires careful handling to prevent damage to the underlying layers. Despite the delicate nature of this process, SEM imaging reveals a successful, secure connection without damage to the underlying layers. Lastly, applying the ZnS:Cu-PDMS layer as an encapsulation and light-emitting layer seems straightforward.

### Performance Assessment

The performance assessment of the fiber-shaped sensor encompassed three main facets: the I-V characteristics, the on-off switching response, and the drop-tower testing for impact detection.

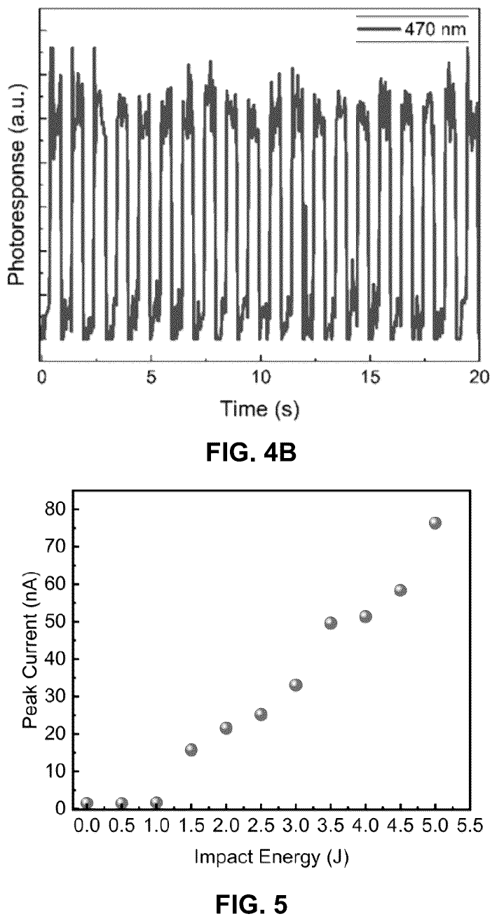

Initial tests focused on characterizing the I-V properties of the sensor before its embedment in the composite structure. These I-V measurements showed a distinct response under different illumination conditions. Upon illumination, the sensor exhibited a strong photocurrent response, indicating its photosensitivity, which is important to its function as a mechanoluminescent sensor, as shown in FIGS. 4A-4B.

Subsequently, the on-off switching performance of the sensor was assessed by measuring its time-dependent photocurrent response to intermittent illumination. This test further confirmed the sensor's light sensitivity, demonstrating a stable and repeatable on-off switching behavior. Notably, the sensor responded almost instantaneously to the changes in illumination, indicating its fast response time, which is important for real-time impact detection.

Following these preliminary tests, the sensor was embedded in an exemplary composite structure, and its performance was assessed under real-world conditions using a drop-tower testing setup. The sensor's output was collected and analyzed under a range of impact energies from 0.5 to 5 Joules, focusing on low-energy impacts that could potentially lead to BVID, a concern in composite structures.

The sensor detected impact energies above a threshold of 1.5 Joules, demonstrating its potential for real-world applications where low-energy impacts might lead to BVID. Further, the sensor's output exhibited a linear relationship with the impact energy above this threshold, as seen in FIG. 5 and evidenced by a correlation coefficient of 0.96. This linearity simplifies the interpretation of sensor signals in terms of impact energy, significantly enhancing the sensor's potential applicability in SHM. The sensor's sensitivity, defined by the change in output per unit change in impact energy, was also assessed. This sensitivity, coupled with the ability to detect low-energy impacts, underscores the sensor's suitability for real-time monitoring of composite structures.

In conclusion, the performance assessment validated the promising capabilities of the fiber-shaped sensor in detecting and quantifying low-energy impact events in composite structures. The sensor showed a strong photosensitive response, rapid on-off switching, and a robust linear relationship between output and impact energy. This combination of features, high sensitivity, and quick response time makes it a potent tool for real-time structural health monitoring in composite structures.

### Mechanical Intrusiveness

The impact of sensor integration on the mechanical performance of the composite material was evaluated using stress-strain curves for specimens with and without embedded sensors. Both planar and fiber sensors were considered for comparison.

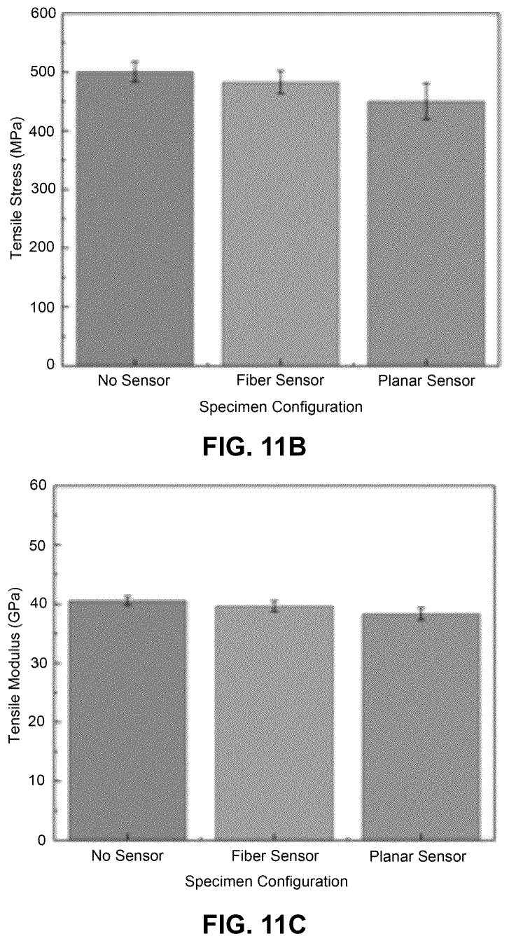

The experimental outcomes indicate a decrease in ultimate strength upon sensor integration within the composite structure. Specifically, pristine samples demonstrated higher ultimate strength and modulus than those with embedded sensors. When fiber sensors were embedded within the composite, a 3.6% reduction in tensile strength and a 2.3% reduction in tensile modulus were observed. In contrast, embedding planar sensors led to a more significant decline in overall tensile properties, with a decrease of 10.1% in tensile strength and 5.5% in tensile modulus. FIGS. 11A-11C present a summary of the tensile testing results.

Further statistical analysis was conducted using Minitab software, employing an ANOVA test to evaluate the statistical significance of the observed differences. It was determined that reductions in tensile strength and modulus due to fiber sensors were not statistically significant compared to baseline samples with a 95% confidence level. However, decreases in tensile strength and modulus due to planar sensors were statistically significant at the same confidence level.

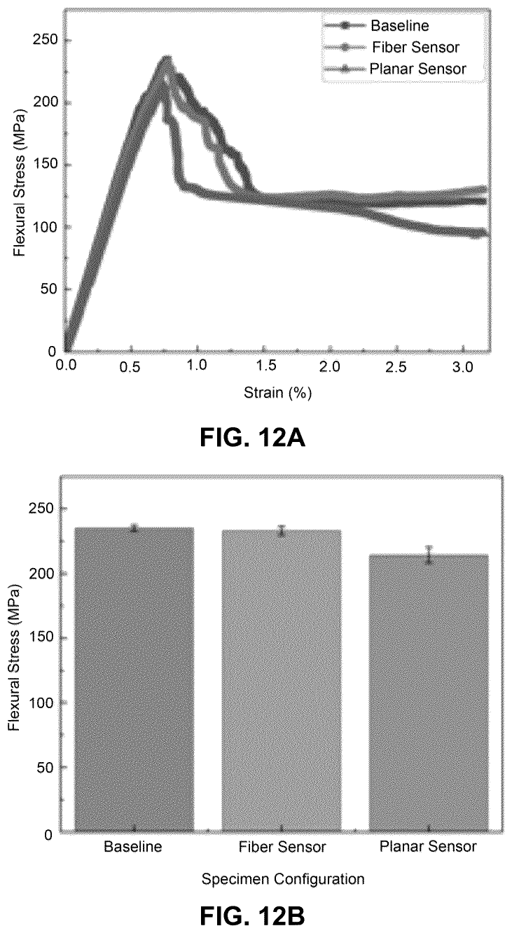

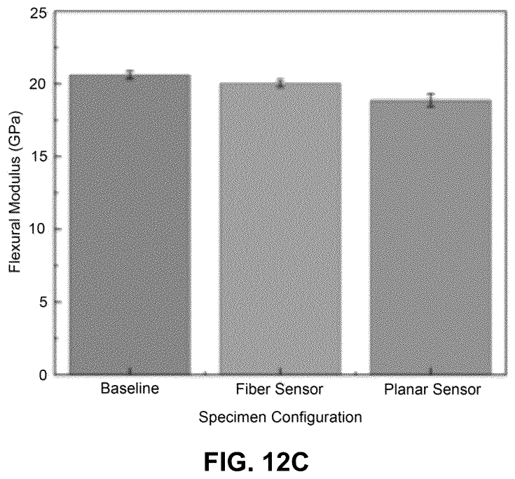

Results from the flexural testing of specimens with and without sensors are consolidated in FIGS. 12A-12C. Fiber sensors resulted in a 2.8% reduction in flexural strength and a 0.8% reduction in flexural modulus. Including planar sensors contributed to an 8.4% reduction in flexural strength and an 8.8% reduction in flexural modulus. The ANOVA test confirmed that flexural strength and modulus reductions due to fiber sensors were not statistically significant compared to the baseline samples at a 95% confidence level. However, reductions due to planar sensors were statistically significant at the same confidence level.

An examination of the micromechanical behavior of the composite material in the presence of sensors provides insights into the observed differences in mechanical properties. Sensors introduce potential failure modes such as cracks, delamination, and other discontinuities, influencing the composite's load-carrying capacity.

Planar sensors embedded within the composite's midplane disrupt the continuity of the woven CFs due to their size, thickness, and rigidity. This disruption leads to less efficient load transfer, increasing the risk of microcracking at the sensor-composite interface. Moreover, the mismatch in stiffness between the planar sensor and the composite matrix can generate localized stress concentrations, initiating matrix cracking and possibly leading to fiber breakage. The presence of planar sensors also contributes to interlaminar shear stress, increasing the risk of delamination. These micromechanical failure modes are responsible for decreased tensile and flexural properties.

On the other hand, integrating the fiber sensor fabricated from CNT yarns has less impact on the composite's structure. The small diameter and flexibility of the yarns allow them to conform more effectively to the woven CFs, thereby minimizing disruption. Still, the presence of the fiber sensor can introduce some stress concentrations within the composite, albeit to a lesser degree than the planar sensor. These stress concentrations could initiate microcracks in the matrix or at the fiber-matrix interface, reducing mechanical properties.

While the fiber sensor does not significantly compromise the mechanical properties of the composite material, its size of approximately 200 micrometers, considerably larger than the carbon fibers' size of around 5-10 micrometers, might become a factor when facing real-world cyclic loading. Cyclic loading, common in structural applications, applies stress in a repeating pattern, which may present challenges due to the sensor's larger size. Under these conditions, the larger sensor could introduce stress concentrations in the composite material that could lead to accelerated fatigue and potentially result in structural failure over time.

In conclusion, the mechanical intrusiveness assessment presented here illustrates that while the inclusion of sensors within the composite structure impacts its mechanical properties to some extent, the effect is significantly less pronounced for fiber sensors than planar sensors.

### Example 2: Results and Discussion

An investigation into the characteristics and performance of the ML-Perovskite sensor has been conducted. Emphasis is placed on the details of fabrication steps, the complex properties of the materials used, and the sensor's behavior under mechanical stress. An initial examination of the electrical behavior of the fiber-shaped ML-Perovskite sensor was conducted through the I-V curve measurements. The dark current, which represents the baseline noise level intrinsic to photodetector devices, was approximately 10⁻⁹ A. This value is sufficiently low to permit the discernment of signals from the ML layer against the backdrop of this noise. Maintaining a low dark current in photodetectors is directly related to the sensor's overall sensitivity. A lower dark current typically enables a more sensitive response, as the sensor signal is not masked by high intrinsic noise.

The I-V curve of the sensor illustrated an increase in current output under illuminated conditions, coupled with a notable shift towards the right, as seen in FIG. 4A. This distinctive shift corroborates the successful operation of the perovskite layer, which, as a photodetector, is expected to generate an electric current upon receiving the light emitted from the mechanoluminescent layer.

The sensor's response characteristics were further investigated by subjecting it to a 60 Hz blinking blue LED light source. The sensor exhibited repetitive and consistent signals (FIG. 4B), underscoring its response's reliability and potential for real-world applications where repetitive stress detection is expected in order to effectively implement the sensor in structural health monitoring scenarios, where consistent and reliable signal generation in response to mechanical changes is paramount.

In the investigation of the sensor's response under various impact energy levels from 0.5 to 5 J, it was established that the sensor could successfully detect energies above 1.5 J. Significantly, above this threshold, the sensor response exhibited a linear relationship with the increasing impact energy, as observed in FIG. 5. This linear trend, characterized by a correlation of 0.96, is a fundamental property of mechanoluminescence and is particularly advantageous for the sensor's application in SHM, as it simplifies the interpretation of the sensor signal in terms of impact energy.

The focus of the study is on low-energy impacts, specifically those that could result in barely visible impact damage (BVID). Consequently, energies exceeding 5 J, which would typically induce more evident damage, were not included in the scope of this investigation. During an impact event, the energy propagates through the composite structure, generating mechanical stress. This stress triggers the mechanoluminescence process in the ZnS:Cu-PDMS layer of the fiber-shaped sensor, which results in light emission. This light is subsequently detected and converted into an electrical signal by the perovskite photodetector layer, creating a correlation between the impact energy and the sensor's signal output.

The fiber-shaped sensor design, with the sensor woven within the composite fibers, offers a significant advantage over the planar configurations, as it is less intrusive and seamlessly integrates with the composite system. This intrinsic integration potentially enhances the accuracy and reliability of sensing, as the sensor is in direct contact with the surrounding material and less susceptible to external disruptions.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

1. Giurgiutiu V 2020 Structural health monitoring (SHM) of aerospace composites Polymer Composites in the Aerospace Industry (Elsevier) pp 491-558
2. Guemes A, et al 2020 Structural Health Monitoring for Advanced Composite Structures: A Review J. Compos. Sci. 4 13
3. Norkhairunnisa M, et al. 2022 Evolution of Aerospace Composite Materials Advanced Composites in Aerospace Engineering Applications ed N Mazlan, S M Sapuan and R A Ilyas (Cham: Springer International Publishing) pp 367-85
4. Rocha H, et al. 2021 Sensors for process and structural health monitoring of aerospace composites: A review Engineering Structures 237 112231
5. Ferreira P M, et al. 2022 Embedded Sensors for Structural Health Monitoring: Methodologies and Applications Review Sensors 22 8320
6. Tuloup C, et al. 2019 On the use of in-situ piezoelectric sensors for the manufacturing and structural health monitoring of polymer-matrix composites: A literature review Composite Structures 215 127-49
7. Tuloup C, et al. 2019 On the manufacturing, integration, and wiring techniques of in situ piezoelectric devices for the manufacturing and structural health monitoring of polymer-matrix composites: A literature review Journal of Intelligent Material Systems and Structures 30 2351-81
8. Aller B, et al. 2022 Health Monitoring of High Strain Composites Using Embedded Fiber Bragg Grating Sensors AIAA SCITECH 2022 Forum AIAA SCITECH 2022 Forum (San Diego, CA & Virtual: American Institute of Aeronautics and Astronautics)
9. Janeliukstis R, et al. 2021 Smart Composite Structures with Embedded Sensors for Load and Damage Monitoring—A Review Mech Compos Mater 57 131-52
10. Aly K, et al. 2019 Real-time impact damage sensing and localization in composites through embedded aligned carbon nanotube sheets Composites Part B: Engineering 162 522-31
11. Hornig A, et al. 2022 Embedded sensing and actuating in CFRP composite structures-concept and technology demonstration for tailored embeddable sensor-actuator layers (TEmSAL) Smart Mater. Struct. 31 095007
12. Braga Carani L, et al. 2021 Embedded Perovskite-Mechanoluminescent Sensor for Applications in Composite Materials European Workshop on Structural Health Monitoring Lecture Notes in Civil Engineering vol 128, ed P Rizzo and A Milazzo (Cham: Springer International Publishing) pp 603-11
13. Carani L B, et al. 2022 Impact sensing and localization in composites structures with embedded mechanoluminescence-perovskite sensors Sensors and Actuators A: Physical 346 113843
14. Shohag M A S, et al. 2020 Fully Integrated Mechanoluminescent Devices with Nanometer-Thick Perovskite Film as Self-Powered Flexible Sensor for Dynamic Pressure Sensing ACS Appl. Nano Mater. 3 6749-56
15. Carani L B, et al. 2020 Performance Analysis of Embedded Mechanoluminescence-Perovskite Self-Powered Pressure Sensor for Structural Health Monitoring J. Compos. Sci. 4

What is claimed is:

1. A fiber-shaped mechanoluminescent perovskite sensor comprising:
a core electrode comprising carbon nanotube yarn;
an SnO₂ layer deposited on the core electrode;
a perovskite active layer in contact with the SnO₂ layer;
a second electrode comprising carbon nanotube yarn in contact with the perovskite active layer; and
a mechanoluminescent layer encapsulating the sensor.

2. The sensor of claim 1, wherein the core electrode comprises a plurality of carbon nanotube yarn strands, wherein the plurality of carbon nanotube yarn strands are braided together.

3. The sensor of claim 2, wherein the strands are braided using a kumihimo technique or a Maypole braider.

4. The sensor of claim 2, wherein the plurality of individual carbon nanotube yarn strands consists of four strands.

5. The sensor of claim 1, wherein the perovskite active layer comprises a methylammonium lead halide perovskite.

6. The sensor of claim 5, wherein the methylammonium lead halide perovskite has the formula MAPb(BrₛI₁₋ₓ)₃, wherein x is from 0.05 to 0.9.

7. The sensor of claim 6, wherein x is 0.1.

8. The sensor of claim 1, wherein the second electrode is wrapped around the perovskite active layer in a spiral shape.

9. The sensor of claim 1, wherein the second electrode comprises a plurality of carbon nanotube yarn strands, wherein the plurality of carbon nanotube yarn strands are braided together.

10. The sensor of claim 9, wherein the strands are braided using a kumihimo technique or a Maypole braider.

11. The sensor of claim 9, wherein the plurality of individual carbon nanotube yarn strands consists of four strands.

12. The sensor of claim 1, wherein the mechanoluminescent layer comprises at least one metal or metal chalcogenide and a polymeric material.

13. The sensor of claim 12, wherein the metal or metal chalcogenide comprises Cu, ZnS, or both Cu and ZnS.

14. The sensor of claim 12, wherein the polymeric material comprises polydimethylsiloxane.

15. A fiber-shaped mechanoluminescent perovskite sensor produced by the method comprising:
(a) depositing a layer of SnO₂ on a core CNT yarn;
(b) applying a perovskite active layer to the SnO₂;
(c) wrapping a second CNT yarn around the perovskite active layer to form a wrapped sensor; and
(d) encapsulating the wrapped sensor with a mechanoluminescent layer.

16. A method of sensing impact damage to a composite material comprising the sensor of claim 1, the method comprising:
(a) emission of light by the mechanoluminescent layer, wherein light emission occurs upon detection of an impact energy;
(b) conversion of the light to an electrical signal by the perovskite active layer; and
(c) detecting the electrical signal.

17. A composite material comprising one or more sensors of claim 1.

18. The composite material of claim 17, wherein the composite material is a composite laminate material.

19. The composite material of claim 18, wherein the composite laminate material comprises one or more carbon fiber (CF) layers, one or more glass fiber (GF) layers, or any combination thereof.

20. An article comprising the composite material of claim 17, wherein the article comprises an aerospace component, an infrastructure component, an automotive component, an energy production component, or an article of sporting equipment.
